(19) United States
(12) Patent Application Publication
(10) Pub. No.: US 2023/0080756 A1
(43) Pub. Date: Mar. 16, 2023

(54) WORK PROCESS-BASED DECISION SUPPORT SYSTEM FOR DISASTER SITUATION MANAGEMENT AND METHOD USING THE SAME

(71) Applicant: ELECTRONICS AND TELECOMMUNICATIONS RESEARCH INSTITUTE, Daejeon (KR)

(72) Inventors: Hyesun LEE, Daejeon (KR); Sun-Hwa LIM, Daejeon (KR); Sang Gi HONG, Daejeon (KR); Soyoung PARK, Daejeon (KR); Kang Bok LEE, Daejeon (KR)

(73) Assignee: ELECTRONICS AND TELECOMMUNICATIONS RESEARCH INSTITUTE, Daejeon (KR)

(21) Appl. No.: 17/721,528

(22) Filed: Apr. 15, 2022

(30) Foreign Application Priority Data
Sep. 9, 2021 (KR) 10-2021-0120556

(51) Int. Cl. G06Q 10/06; G06F 16/26

(52) U.S. Cl. CPC G06Q 10/06313; G06Q 10/063114; G06Q 10/0637; G06F 16/26

(57) ABSTRACT

Provided are a system and method for providing customized decision support information required for decision-making for each disaster type and each situation management work process stage based on a situation management work process. According to the present invention, a decision support system for disaster situation management includes a situation management service system for each disaster type that provides a situation management service for a specific disaster type, a big data management system configured to collect, store, and manage situation management big data used for disaster situation management, a decision support platform configured to manage a situation management work process for each disaster, and provide decision support information necessary for each disaster type and each situation management work process stage, and a situation information sharing and collaboration system configured to visualize and provide situation management decision support information on a situation board in a specific situation room.

### CROSS-REFERENCE TO RELATED APPLICATION

This application claims priority to and the benefit of Korean Patent Application No. 10-2021-0120556, filed on Sep. 9, 2021, the disclosure of which is incorporated herein by reference in its entirety.

### BACKGROUND

### 1. Field of the Invention

The present invention relates to a decision support system for disaster situation management and a method using the same, and more particularly, to a system and method for providing customized decision support information necessary for decision-making for each disaster type and each situation management work process stage based on the situation management work process.

### 2. Discussion of Related Art

In order to support disaster situation management work, a technology related to a system that provides specific inference information, a technology related to a disaster safety integrated situation management system, and a situation management information mapping technology have been disclosed. As the system for providing specific inference information, systems that provide water level detection information, evacuation route information, still image information, and the like have been proposed, and as the disaster safety integrated situation management system, systems such as big data-based early security control and a geographic information system (GIS)-based integrated management system have been proposed.

In addition, a technology related to a system for providing specific inference information to support general situation management work has been disclosed. For example, there are user-centered situation information management devices and methods, devices and methods for managing complex situation information, methods for providing complex situation information, and dynamic situation management devices and methods for coping with real-time changes in factory situations.

In the related art, methods of providing specific inference information to support situation management work have been proposed, but for systematic situation management work, there is a need to provide customized information for each situation management type and each situation management work process stage.

### RELATED ART DOCUMENT

### Patent Document

(Patent Document 0001) Korean Patent No. 10-1724259
(Patent Document 0002) Korean Patent No. 10-1724260

### SUMMARY OF THE INVENTION

The present invention is directed to providing a system and method for providing customized decision support information necessary for each disaster type and each situation management work process stage based on the disaster situation management work process in order to support the quick and accurate decision-making of a situation manager in a disaster situation.

According to an aspect of the present invention, there is provided a decision support system for disaster situation management including: a situation management service system for each disaster type that provides a situation management service for a specific disaster type; a big data management system configured to collect, store, and manage situation management big data used for disaster situation management; a decision support platform configured to manage a situation management work process for each disaster, and provide decision support information necessary for each disaster type and each situation management work process stage; and a situation information sharing and collaboration system configured to visualize and provide situation management decision support information on a situation board in a specific situation room.

The situation management service system for each disaster type may acquire situation management work process information for a specific disaster type, and collect, monitor, and analyze information necessary for a current situation management work process stage of the specific disaster type.

The situation management service system for each disaster type may acquire the situation management work process information for a specific disaster type, and provide decision support information necessary for a current situation management work process stage of a target disaster of a specific disaster type to the decision support platform.

The situation management service system for each disaster type may provide a situation management information visualization viewer necessary for a current situation management work process stage of a specific disaster type to the situation information sharing and collaboration system.

The big data management system may acquire the situation management information from an external system linked for a common disaster that provides situation management information related to multiple disaster types.

The big data management system may provide situation management information related to a relevant disaster type to the situation management service system for each disaster type.

The big data management system may provide situation management information necessary for situation management of a target disaster to the decision support platform and the situation information sharing and collaboration system.

The decision support platform may provide current situation management work process information for a situation management target disaster to the situation management service system in charge of a relevant disaster type and the situation information sharing and collaboration system.

The decision support platform may provide situation management work process-based decision support information for a situation management target disaster to the situation manager through a situation manager work personal computer (PC).

The decision support platform may acquire situation management dynamic information for a situation management target disaster, analyze the situation management dynamic information, and if necessary, update current situation management work process information for the disaster.

The situation information sharing and collaboration system may acquire current situation management work process information for a specific situation management target disaster, and acquire decision support information necessary for a current work process stage and provide the acquired decision support information to the situation board.

According to another aspect of the present invention, there is provided a method of supporting disaster situation management decision-making including: acquiring situation management information for a situation management target disaster; sharing work process information for the situation management target disaster inside a decision support system for disaster situation management; providing decision support information necessary for a current situation management work process stage to an external system based on the work process information; and updating current situation management work process information for the situation management target disaster.

In the acquiring of the situation management information, the situation management information necessary for the current situation management work process stage of the situation management target disaster may be acquired.

In the sharing of the work process information, the current situation management work process information for the situation management target disaster may be provided to a situation management service system and a situation information sharing and collaboration system of a relevant disaster type.

The providing of the decision support information to the external system may include: collecting situation management information necessary for the current situation management work process stage and generating the decision support information necessary for the current situation management work process stage by performing an analysis on the situation management information; and providing the decision support information necessary for the current situation management work process stage to a situation manager through a situation manager work PC.

The providing of the decision support information to the external system may include: collecting situation management information necessary for the current situation management work process stage and generating a situation management information visualization viewer necessary for the current situation management work process stage by performing an analysis on the situation management information; and providing the situation management information visualization viewer to a situation management decision maker through a situation board.

The updating of the work process information may include: acquiring situation management dynamic information for decision-making and situation changes of the current situation management work process stage of the situation management target disaster; and analyzing the situation management dynamic information to determine whether a situation management work process update is necessary, and if it is necessary to update the situation management work process, updating the current situation management work process information for the disaster.

The method may further include, before the acquiring of the situation management information, acquiring situation management information from the external system and storing and managing situation management big data.

The storing and managing of the situation management big data may include: acquiring situation management information from the external system and storing situation management big data; and acquiring situation management information for each disaster type and storing situation management big data.

According to still another aspect of the present invention, there is provided a method of supporting disaster situation management decision-making including: acquiring situation management information from an external system linked for each disaster type of situation management target disaster; generating decision support information necessary for a current situation management work process stage based on work process information for the situation management target disaster; providing the decision support information to the external system; and updating current situation management work process information for the situation management target disaster.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a decision support system for disaster situation management according to an embodiment of the present invention;

FIG. 2 is a block diagram illustrating the configuration of the decision support system for disaster situation management and operations associated with external systems according to an embodiment of the present invention;

FIG. 3 is a block diagram illustrating an actual deployment structure of a decision support system for disaster situation management according to an embodiment of the present invention;

FIGS. 4A and 4B are block diagrams for describing an embodiment of operations of a decision support system for disaster situation management for one situation room; and

FIGS. 5 and 6 are flowcharts for describing a method of supporting disaster situation management decision-making according to an embodiment of the present invention.

### DETAILED DESCRIPTION OF EXEMPLARY EMBODIMENTS

Various advantages and features of the present invention and methods of accomplishing them will become apparent from the following description of embodiments with reference to the accompanying drawings. However, the present invention is not limited to the embodiments disclosed herein, but will be implemented in various forms. The embodiments make contents of the present invention thorough and are provided so that those skilled in the art can easily understand the scope of the present invention. Therefore, the present invention will be defined by the scope of the appended claims. Meanwhile, terms used in the present specification are for describing the embodiments rather than limiting the present invention. Unless otherwise stated, a singular form includes a plural form in the present specification. The terms “comprise” and/or “comprising” used in the herein refer to stated components, steps, operations, and/or elements but do not exclude the presence or addition of one or more other components, steps, operations, and/or elements.

When it is decided that the detailed description of the known art related to the present invention may obscure the gist of the present invention, the detailed description thereof will be omitted.

Hereinafter, embodiments of the present invention will be described with reference to the accompanying drawings. The same means will be denoted by the same reference numerals throughout the accompanying drawings in order to facilitate the general understanding of the present invention in describing the present invention.

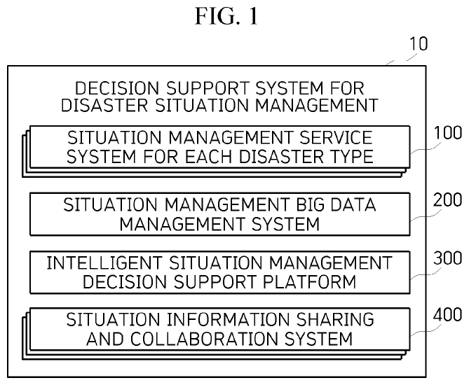

FIG. 1 is a block diagram illustrating a configuration of a work process-based decision support system 10 for disaster situation management according to an embodiment of the present invention.

As illustrated in FIG. 1, the work process-based decision support system 10 for disaster situation management (hereinafter “decision support system for disaster situation management”) according to the embodiment of the present invention includes a situation management service system 100 for each disaster type, a situation management big data management system 200 (hereinafter, “big data management system”), an intelligent situation management decision support platform 300 (hereinafter, “decision support platform”), a situation information sharing and collaboration system 400.

The situation management service system 100 for each disaster type, the big data management system 200, the decision support platform 300, and the situation information sharing and collaboration system 400 are subsystems of the decision support system 10 for disaster situation management. Among them, the situation management service system 100 for each disaster type and the situation information sharing and collaboration system 400 may each be provided as one or more systems in one decision support system 10 for disaster situation management.

The situation management service system 100 for each disaster type is a system that provides a situation management service for a specific disaster type. In addition, the situation management service system 100 for each disaster type acquires situation management work process information for the specific disaster type, and provides information collection, monitoring, analysis, and decision support information necessary for a current situation management work process stage of the specific disaster type. The situation management service system 100 for each disaster type generates decision support information (situation management dynamic information or a situation management information visualization viewer) necessary for the current situation management work process stage through the above analysis. The situation management service system 100 for each disaster type provides decision support information necessary for the current situation management work process stage of the specific disaster type in the form of situation management dynamic information and situation management information visualization viewer.

The big data management system 200 is a system that collects, stores, and manages situation management big data used for disaster situation management. The big data may be used for disaster situation management of a specific disaster type, but may also be used for disaster situation management of multiple disaster types. In addition, the big data management system 200 enables other systems requiring situation management big data to inquire about or receive disaster situation management big data managed by the big data management system 200.

The decision support platform 300 is a system that manages the situation management work process for each disaster for multiple disasters of multiple disaster types, which are a target of situation management, and provides customized decision support information necessary for each disaster type and each situation management work process stage. The number of disaster types or disasters may be one. In addition, the decision support platform 300 performs control to provide the current situation management work process information for each situation management target disaster to other systems and provide customized information necessary for each disaster type and the current situation management work process stage. In addition, the decision support platform 300 provides situation management work process-based decision support information for each situation management target disaster to a situation manager. The decision support platform 300 acquires situation management dynamic information for the relevant disaster of each situation management target disaster, analyzes the situation management dynamic information, and updates the current situation management work process information for the relevant disaster if necessary.

The situation information sharing and collaboration system 400 is a system for visualizing situation management decision support information on a situation board in a specific situation room. The situation information sharing and collaboration system 400 acquires current situation management work process information for a specific situation management target disaster, and acquires the situation management information and situation management information visualization viewer necessary for the current situation management work process stage of the relevant disaster type, and provides the situation management work process-based decision support information to the situation board.

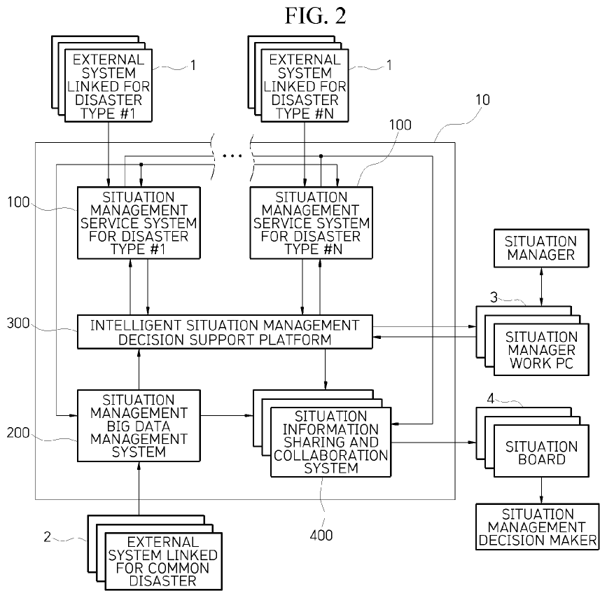

FIG. 2 is a block diagram illustrating the configuration of the decision support system for disaster situation management and operations associated with external systems according to an embodiment of the present invention.

As illustrated in FIG. 2, the decision support system 10 for disaster situation management operates by being linked with an external system. As the external system, there are an external system 1 linked for each disaster type, an external system 2 linked for a common disaster, a situation manager work personal computer (PC) 3, and a situation board 4. There are at least one external system 1 linked for each disaster type, at least one external system 2 linked for a common disaster, at least one situation manager work PC 3, and at least one situation board 4.

The situation management service system 100 for each disaster type is a system that provides a situation management service for a specific disaster type. The situation management service refers to a service that acquires situation management work process information and situation management information for the specific disaster type, and collects, monitors, and analyzes information necessary for the current situation management work process stage of the specific disaster type and provides decision support information. Examples of disaster types include social disasters such as infectious diseases, large-scale fires in high-density facilities, and hazardous chemical spills, natural disasters such as typhoons, earthquakes, and droughts, and complex disasters such as urban wildfires and urban floods.

The situation management service system 100 for each disaster type acquires the situation management work process information for the specific disaster type, and collects, monitors, and analyzes information necessary for the current situation management work process stage of a specific disaster type and provides the decision support information. The decision support information provided by the situation management service system 100 for each disaster type includes abnormal situation and disaster situation analysis and prediction information necessary for the current situation management work process stage of the relevant disaster type. Examples of decision support information provided by the situation management service system 100 for each disaster type include disaster occurrence prediction information, disaster spread prediction information, and disaster damage prediction information.

The situation management service system 100 for each disaster type collects, monitors, and analyzes the situation management information (the information collected from the external system linked for each disaster type and the big data management system) necessary for the current situation management work process stage based on the situation management work process information for the target disaster acquired from the decision support platform 300. The situation management service system 100 for each disaster type generates decision support information (situation management dynamic information or a situation management information visualization viewer) necessary for the current situation management work process stage through the analysis of the collected situation management information.

The situation management service system 100 for each disaster type provides the decision support information necessary for the current situation management work process stage of the specific disaster type. The situation management service system 100 for each disaster type provides the decision support information in the form of the situation management dynamic information or the situation management information visualization viewer. The situation management dynamic information is provided in the form of standardized data, and the situation management information visualization viewer is provided in the form of visualized information. As an example of the situation management information visualization viewer, there is a web viewer that may access a uniform resource locator (URL) from a web browser and confirm the URL. In this case, providing the decision support information by the situation management service system 100 for each disaster type in the form of the web viewer is implemented in such a way that the situation management information visualization viewer operates externally in the form of an independent web service, and the decision support platform 300 or the situation information sharing and collaboration system 400 calls the URL of the visualization viewer and is linked with the visualization viewer. As another example, the situation management service system 100 for each disaster type is implemented in such a way that the situation management service system 100 for each disaster type provides a situation management information visualization viewer as software that needs to be installed and the decision support platform 300 or the situation information sharing and collaboration system 400 installs the relevant software to be linked with the situation management service system 100 for each disaster type.

The situation management service system 100 for each disaster type acquires situation management information necessary for situation management of a specific disaster type from the relevant external system 1 linked for each disaster type. That is, the situation management service system 100 for each disaster type acquires the situation management information that needs to be separately acquired according to the type of disaster from the external system 1 linked for each disaster type. The situation management service system 100 for each disaster type may provide the situation management information to the big data management system 200.

In addition, the situation management service system 100 for each disaster type acquires the situation management information necessary for the situation management of the specific disaster type from the big data management system 200.

In addition, the situation management service system 100 for each disaster type acquires the situation management work process information for the specific disaster type from the decision support platform 300.

The situation management service system 100 for each disaster type provides the situation management information related to the situation management of the specific disaster type to the big data management system 200.

In addition, the situation management service system 100 for each disaster type provides the situation management dynamic information and the situation management information visualization viewer necessary for the current situation management work process stage of a target disaster of the specific disaster type to the decision support platform 300. The situation management dynamic information and the situation management information visualization viewer correspond to the decision support information.

In addition, the situation management service system 100 for each disaster type provides the situation management information visualization viewer necessary for the current situation management work process stage of the specific disaster type to the situation information sharing and collaboration system 400.

The big data management system 200 is a system that collects, stores, and manages the situation management big data used for the disaster situation management. The big data may be used for the disaster situation management of the specific disaster type, but may also be used for disaster situation management of multiple disaster types.

Examples of the situation management big data include external system linkage information, common disaster situation information, situation information for each disaster type, past disaster information, abnormal situation determination information, disaster prediction information, wide area/complex disaster scenario, user information, spatial information, etc.

In addition, the big data management system 200 enables other systems in the decision support system 10 for disaster situation management requiring situation management big data to inquire about or receive the disaster situation management big data managed by the big data management system 200.

The big data management system 200 acquires situation management information from the external system 2 linked for a common disaster. The external system 2 linked for a common disaster may be provided as a plurality of systems, and the situation management information may be information related to multiple disaster types.

In addition, the big data management system 200 acquires the situation management information related to the relevant disaster type from the situation management service system 100 for each disaster type. In this case, the situation management service system 100 for each disaster type may be provided as a plurality of systems.

The big data management system 200 may integrate the situation management information acquired from other systems into the disaster situation management big data, and may extract the situation management information from the disaster situation management big data and provide the extracted situation management information to other systems.

The big data management system 200 provides the situation management information related to the relevant disaster type to the situation management service system 100 for each disaster type. In this case, the situation management service system 100 for each disaster type may be provided as a plurality of systems.

In addition, the big data management system 200 provides the situation management information necessary for situation management of a situation management target disaster to the decision support platform 300. The target disaster may be provided as a plurality of disasters.

In addition, the big data management system 200 provides the situation management information necessary for the situation management of the situation management target disaster to the situation information sharing and collaboration system 400. The situation information sharing and collaboration system 400 may be provided as a plurality of systems, and the target disaster may be provided as multiple disasters.

The decision support platform 300 is a system that manages the situation management work process for each disaster for multiple disasters of multiple disaster types, which is a target of situation management, and provides customized decision support information necessary for each disaster type and each situation management work process stage. The number of disaster types or disasters may be one. As an example of the plurality of disasters of the plurality of disaster types, there may be three disasters of a large-scale fire type in a high-density facility and two disasters of an earthquake type.

The decision support platform 300 provides the current situation management work process information for each situation management target disaster to other systems and controls the systems to provide customized information necessary for each disaster type and the current situation management work process stage. The decision support platform 300 provides the current situation management work process information for the relevant disaster of each situation management target disaster to the situation management service system 100 in charge of the relevant disaster type, so the situation management service system 100 of the relevant disaster type provides customized services necessary for the current situation management work process stage. The decision support platform 300 provides the current situation management work process information for the relevant disaster of each situation management target disaster to the situation information sharing and collaboration system 400, so the situation information sharing and collaboration system 400 provides customized information necessary for the current situation management work process stage.

In order to configure the customized decision support information necessary for decision-making at each situation management work process stage of the target disaster, the decision support platform 300 manages the situation management service system 100 of the target disaster type step by step by being linked with the situation management service system 100, applies situation management decision-making rules step by step, and automates the application of these rules. The decision support platform 300 provides the customized decision support information necessary for decision-making at each situation management work process stage of the target disaster configured as described above to the situation manager work PC 3 or situation board 4.

The decision support platform 300 provides the situation management work process-based decision support information for each situation management target disaster to the situation manager through the situation manager work PC 3. The decision support platform 300 provides the decision support information at each situation management work process stage of the target disaster to the situation manager through the situation manager work PC 3. The decision support information based on the work process provided by the decision support platform 300 includes the situation management work process information for the disaster type to which the situation management target disaster corresponds, work information and consideration information necessary for the current situation management work process stage, and monitoring, analysis, and abnormal situation and disaster situation analysis/prediction information necessary for the current situation management work process stage. Examples of the work process-based decision support information include information on the current situation management work process stage of the relevant disaster, information on work to be performed at the current stage, information on considerations to be considered in decision-making at the current stage, and a situation management information visualization viewer necessary for decision-making at the current stage. The work information, consideration information, and situation management information visualization viewer may be provided as one or more viewers. [Table 1] summarizes the decision support information provided by the situation management service system 100 for each disaster type and the decision support platform 300.

TABLE 1

| Division | Provider | Information included |
|---|---|---|
| Decision | Situation | Abnormal situation and disaster |
| support | management | situation analysis and prediction |
| information | service | information necessary for current |
| | system | situation management work process |
| | | stage of relevant disaster type |
| Work process- | Decision support | Situation management work process |
| based decision | platform | information for relevant disaster type, |
| support | | work information and consideration |
| information | | information necessary for current |
| | | situation management work process |
| | | stage, monitoring, analysis, and |
| | | abnormal situation and disaster |
| | | situation analysis and prediction |
| | | information necessary for current |
| | | situation management work process |
| | | stage |

The decision support platform 300 acquires situation management dynamic information for the relevant disaster of each situation management target disaster, analyzes the situation management dynamic information, and updates the current situation management work process information for the relevant disaster if necessary.

Examples of updating the situation management work process information include updating the information on the current situation management work process stage to new stage information, updating the work information to be performed at the current stage to the work information to be performed at the changed stage, updating the consideration information for decision-making at the current stage to the consideration information for decision-making at the changed stage, and updating the situation management information visualization viewer necessary for decision-making at the current stage to the situation management information visualization viewer necessary for decision-making at the changed stage.

The decision support platform 300 manages the situation management service system 100 by being linked with the situation management service system 100 for each key disaster type at each work process stage of the situation management target disaster. The decision support platform 300 acquires the situation management dynamic information or the situation management information visualization viewer necessary for the current situation management work process stage of the situation management target disaster of the relevant disaster type in the situation management service system 100 for each disaster type. In this case, the situation management service system 100 for each disaster type may be provided as a plurality of systems.

In addition, the decision support platform 300 acquires the situation management dynamic information for the decision-making and situation changes of the current situation management work process stage of the target disaster from the situation management service system 100 for the relevant disaster type.

In addition, the decision support platform 300 acquires the situation management information from the big data management system 200. The information is information necessary for situation management of a disaster that is a target of situation management.

In addition, the decision support platform 300 acquires the situation management information necessary for the current situation management work process stage of the situation management target disaster from the big data management system 200.

In addition, the decision support platform 300 acquires the situation management dynamic information for each disaster on the situation management target disaster from the situation manager. That is, the decision support platform 300 acquires the situation management dynamic information for the decision-making and situation changes of the current situation management work process stage of the target disaster from the situation manager work PC 3. The decision support platform 300 reflects the situation management dynamic information to update the current situation management work process information. Specifically, the decision support platform 300 determines whether a stage change of the current situation management work process is necessary, and reflects the situation management dynamic information to update the situation management work process information when the stage change is necessary.

The decision support platform 300 provides the current situation management work process information for the situation management target disaster of the relevant disaster type to the situation management service system 100 for each disaster type. Here, the situation management service system 100 for each disaster type may be provided as a plurality of systems.

In addition, the decision support platform 300 provides the situation management work process-based decision support information for each disaster on the situation management target disaster to the situation manager through the situation manager work PC 3. The situation manager may use the decision support platform 300 via the situation manager work PC 3.

In addition, the decision support platform 300 provides the current situation management work process information for the situation management target disaster to the situation information sharing and collaboration system 400. Here, the situation information sharing and collaboration system 400 may be provided as a plurality of systems.

The information acquired or provided by the decision support platform 300 may relate to multiple disaster types, and relate to multiple disasters.

The situation information sharing and collaboration system 400 is a system for visualizing and providing the situation management information and the situation management decision support information to the situation board 4 in a specific situation room. The situation information sharing and collaboration system 400 is linked with each situation room. Examples of the situation rooms include a central government disaster situation room and each city/province local government disaster situation room. Since the situation information sharing and collaboration system 400 is installed and operated for each situation room, when there are N target situation rooms, there are also N situation information sharing and collaboration systems 400.

The situation information sharing and collaboration system 400 acquires current situation management work process information for a specific situation management target disaster, and acquires the situation management information and situation management information visualization viewer necessary for the current situation management work process stage of the relevant disaster type, and provides the situation management work process-based decision support information to the situation board 4. That is, the situation information sharing and collaboration system 400 acquires the decision support information (information visualization viewer, etc.) necessary for the current work process stage based on the situation management work process information for the specific situation management target disaster and provides the decision support information to the situation board 4.

The situation information sharing and collaboration system 400 acquires the situation management information visualization viewer necessary for the current situation management work process stage of the specific situation management target disaster of the relevant disaster type from the situation management service system 100 for each disaster type. Here, the situation management service system 100 for each disaster type may be provided as a plurality of systems.

In addition, the situation information sharing and collaboration system 400 acquires the current situation management work process information for the specific situation management target disaster from the decision support platform 300.

In addition, the situation information sharing and collaboration system 400 acquires the situation management information necessary for the situation management of the specific situation management target disaster from the big data management system 200.

In addition, the situation information sharing and collaboration system 400 acquires the situation management information necessary for the current work process stage from the big data management system 200, and acquires the situation management information visualization viewer from the situation management service system 100 for the relevant disaster type, based on the situation management work process information for the target disaster acquired from the decision support platform 300.

In addition, the situation information sharing and collaboration system 400 provides the situation management work process-based decision support information for the specific disaster to the situation board 4, thereby allowing the situation board 4 to visualize and provide the information to the situation management decision maker.

The information acquired or provided by the situation information sharing and collaboration system 400 may relate to multiple disaster types, and relate to multiple disasters.

The functions and operations of the external system linked with the decision support system 10 for disaster situation management will be described as follows. The external system includes the external system 1 linked for each disaster type, the external system 2 linked for a common disaster, the situation manager work PC 3, and the situation board 4.

The external system 1 linked for each disaster type provides situation management information related to a specific disaster type. The external system 1 linked for each disaster type provides situation management information related to the relevant disaster type to the relevant situation management service system 100 for each disaster type.

The external system 2 linked for a common disaster provides situation management information. The information may be information related to multiple disaster types. The external system 2 linked for a common disaster provides situation management information related to one or more disaster types to the big data management system 200.

The situation manager work PC 3 is a work PC used by the situation manager in the situation room. The situation manager is connected to the decision support platform 300 using the situation manager work PC 3 and uses the functions of the decision support platform 300. The situation manager work PC 3 acquires the situation management work process-based decision support information for each disaster for the situation management target disaster from the decision support platform 300. The target disaster may be provided as multiple disasters.

The situation manager work PC 3 provides situation management dynamic information for each situation management target disaster to the decision support platform 300. The target disaster may be provided as multiple disasters.

The situation board 4 is a display viewed by the situation management decision maker in the situation room. The situation management decision maker confirms the information necessary for situation management decision-making in a specific disaster through the situation board 4. The situation board 4 acquires situation management work process-based decision support information for a specific disaster from the relevant situation information sharing and collaboration system 400 and visualizes the situation management work process-based decision support information.

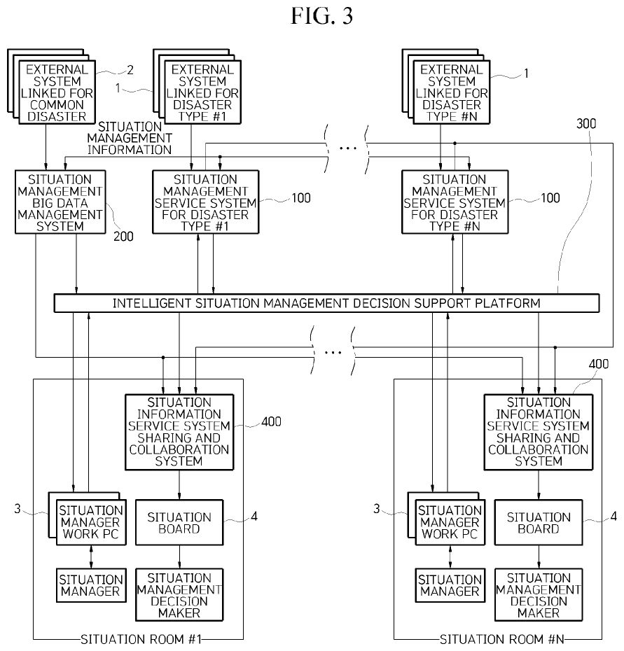

FIG. 3 is a block diagram illustrating an actual deployment structure of a decision support system for disaster situation management according to an embodiment of the present invention.

The information transfer between all the systems excluding the communication between the external system 1 linked for each disaster type and the situation management service system 100 for each disaster type, the communication between the external system 2 linked for a common disaster and the big data management system 200, and the communication between the situation information sharing and collaboration system 400 and the situation board 4 is performed over the Internet.

The communication between the external system 1 linked for each disaster type and the situation management service system 100 for each disaster type and the communication between the external system 2 linked for a common disaster and the big data management system 200 may use communication over the Internet, but for reasons such as security, in some cases, other types of methods such as a method of providing a database or a method of providing a data file may be used. In the embodiment illustrated in FIG. 3, the Internet communication method is used.

Meanwhile, the situation manager work PC 3, the situation board 4, and the situation information sharing and collaboration system 400 are installed and operated independently in each situation room. Basically, one situation board 4 and one situation information sharing and collaboration system 400 are installed and operated in each situation room, but when there are a plurality of situation managers for each situation room, a plurality of situation manager work PCs 3 may be installed and operated. The communication method between the situation information sharing and collaboration system 400 and the situation board 4 may differ depending on the situation room environment. For example, in situation room #1, the situation information sharing and collaboration system 400 and the situation board 4 may communicate over the Internet, and in situation room #2, the situation information sharing and collaboration system 400 and the situation board 4 may communicate through wired communication.

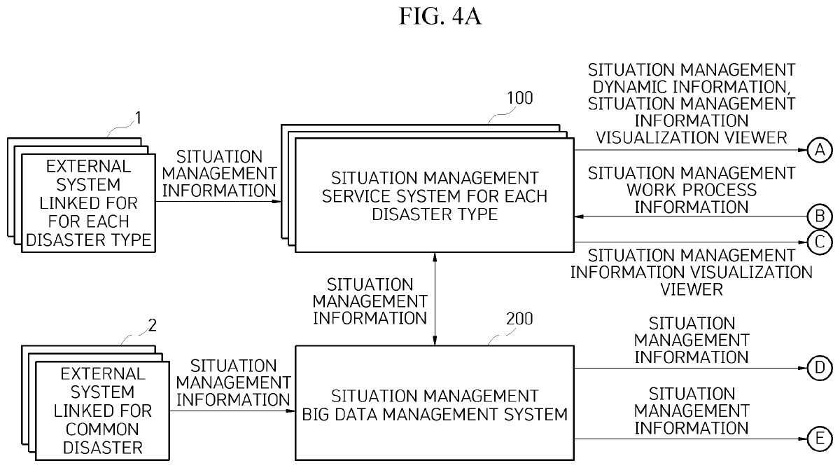

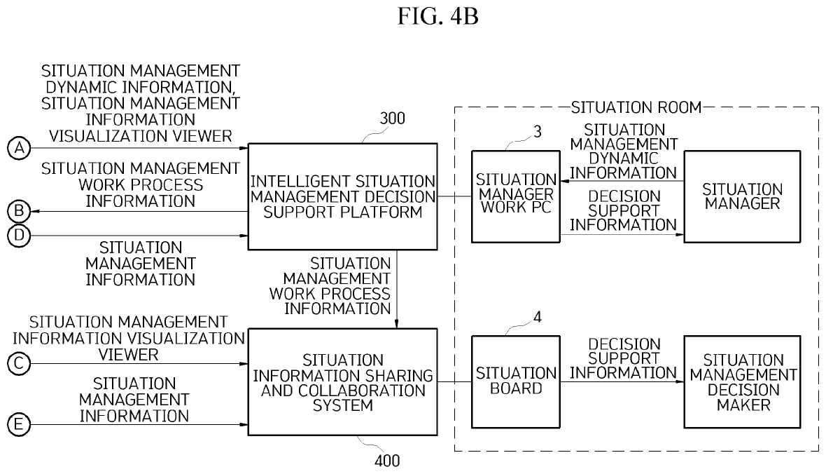

FIGS. 4A and 4B are block diagrams for describing an embodiment of operations of a decision support system for disaster situation management for one situation room.

Hereinafter, an operation method of the decision support system 10 for disaster situation management according to the embodiment of the present invention will be described with reference to FIGS. 4A and 4B.

The operation method of the decision support system 10 for disaster situation management according to the embodiment of the present invention is not limited to the order of description of operations below, and some operations may be performed in a different order from the order of description or in parallel. A specific operation may be repeated, and various other branches and orders that achieve the same or similar results may be implemented. In addition, all operations to be described below may not be required for implementation of the operation method.

1) The big data management system 200 acquires the situation management information from the external system 2 linked for a common disaster to store and manage the situation management big data, and provides inquiry and provision functions to other systems.

2) In the case of the situation management information that needs to be separately acquired for each disaster type, the situation management service system 100 for each disaster type acquires the situation management information from the external system 1 linked for each disaster type and provides the acquired situation management information to the big data management system 200.

3) The big data management system 200 acquires the situation management information from the situation management service system 100 for each disaster type to store and manage the situation management big data, and provides inquiry and provision functions to other systems.

4) The decision support platform 300 manages the situation management work process for multiple target disasters of multiple situation management types. However, the number of types of situation management or target disasters may be one.

5) In addition, the decision support platform 300 acquires the situation management information necessary for the current situation management work process stage of the situation management target disaster from the big data management system 200.

6) The decision support platform 300 provides the current situation management work process information for the situation management target disaster to the situation management service system 100 for the relevant disaster type and the and situation information sharing and collaboration system 400.

7) The situation management service system 100 for each disaster type collects, monitors, and analyzes the situation management information (the information collected from the external system 1 linked for each disaster type and the big data management system) necessary for the current situation management work process stage based on the situation management work process information for the target disaster acquired from the decision support platform 300. The situation management service system 100 for each disaster type generates decision support information (situation management dynamic information or a situation management information visualization viewer) necessary for the current situation management work process stage through the analysis of the collected situation management information.

8) The situation management service system 100 for each disaster type provides the decision support information necessary for the current situation management work process stage of a target disaster to the decision support platform 300 in the form of the situation management dynamic information and the situation management information visualization viewer.

9) The decision support platform 300 provides the situation management work process-based decision support information (information on the current situation management work process stage of the relevant disaster, work information to be performed at the current stage, information on considerations to be considered in decision-making at the current stage, an information visualization viewer necessary for decision-making at the current stage, etc.) to the situation manager through the situation manager work PC 3. The work information, consideration information, and information visualization viewer may be a plurality of pieces of information.

10) The situation information sharing and collaboration system 400 acquires the situation management information necessary for the current work process stage from the big data management system 200, and acquires the situation management information visualization viewer from the situation management service system 100 for the relevant disaster type, based on the situation management work process information for the target disaster acquired from the decision support platform 300.

11) The situation information sharing and collaboration system 400 provides the situation management work process-based decision support information to the situation board 4 and visualizes the situation management work process-based decision support information to the situation management decision maker.

12) The decision support platform 300 acquires the situation management dynamic information for the decision-making and situation changes of the current situation management work process stage of the target disaster from the situation management service system 100 for the relevant disaster type or situation manager work PC 3.

13) The decision support platform 300 analyzes the situation management dynamic information acquired for the target disaster to determine whether the situation management work process needs to be updated, and if necessary, updates the current situation management work process information of the relevant disaster.

14) Operations are repeatedly performed from “operation 5)” on the updated situation management work process information.

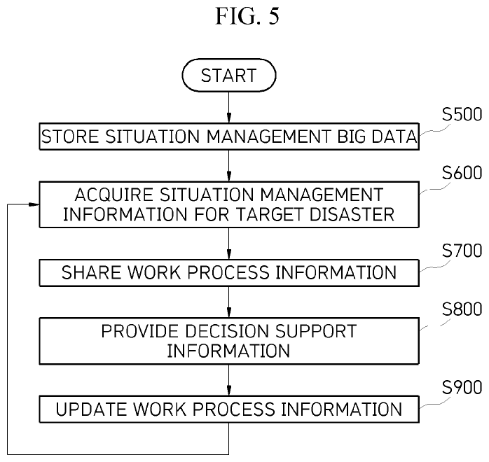

FIG. 5 is a flowchart for describing a method of supporting disaster situation management decision-making according to an embodiment of the present invention.

As illustrated in FIG. 5, the method of supporting disaster situation management decision-making according to the embodiment of the present invention includes storing situation management big data (S500), acquiring situation management information of a target disaster (S600), sharing work process information (S700), providing decision support information (S800), and updating work process information (S900).

Operation S500 is the operation of storing situation management big data. Operation S500 may be performed at any time in the decision support system 10 for disaster situation management. The decision support system 10 for disaster situation management stores and manages the situation management big data by acquiring situation management information from an external system. As the external system that may provide situation management information, there are the external system 1 linked for each disaster type and the external system 2 linked for a common disaster. The external system 1 linked for each disaster type provides information by being linked with the situation management service system 100 for each disaster type of the decision support system 10 for disaster situation management, and the external system 2 linked for a common disaster provides information by being linked with the big data management system 200 of the decision support system 10 for disaster situation management. The big data management system 200 may acquire the situation management information from the situation management service system 100 for each disaster type. The big data management system 200 may acquire the situation management information from the external system 2 linked for a common disaster or the situation management service system 100 for each disaster type to store and manage the situation management big data.

Operation S600 is an operation of acquiring the situation management information for the situation management target disaster. The decision support platform 300 manages the situation management work process for multiple target disasters of multiple situation management types. However, the number of types of situation management or target disasters may be one. The decision support platform 300 acquires the situation management information necessary for the current situation management work process stage of the situation management target disaster from the big data management system 200.

Operation S700 is an operation in which the decision support system 10 for disaster situation management internally shares work process information. The decision support platform 300 of the decision support system 10 for disaster situation management may provide the current situation management work process information for the situation management target disaster to the situation management service system 100 for each disaster type and the situation information sharing and collaboration system 400, so the situation management service system 100 for each disaster type and the situation information sharing and collaboration system 400 may be operated based on the work process information.

Operation S800 is an operation in which the decision support system 10 for disaster situation management provides the decision support information to an external system. The decision support system 10 for disaster situation management collects and analyzes the situation management information necessary for the current situation management work process stage, generates the decision support information, and provides the generated decision support information to the situation manager work PC 3 or the situation board 4.

Operation S900 is an operation of updating the current situation management work process information. The decision support system 10 for disaster situation management acquires and analyzes the situation management dynamic information for decision-making and situation changes of the current situation management work process stage, and if it is necessary to update the situation management work process, updates the current situation management work process information of the target disaster.

After completion of operation S900, the method may proceed again from operation S600 for the updated situation management work process information.

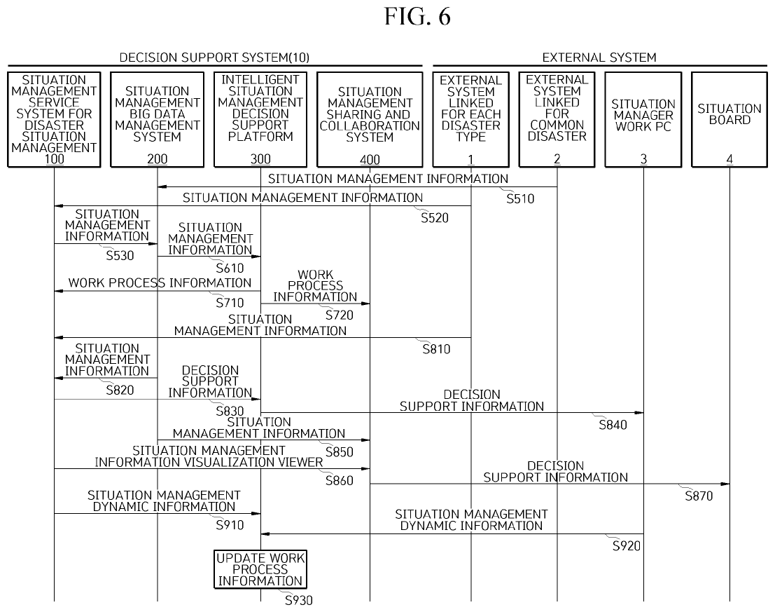

Details of operations S500 to S900 will be described below with reference to FIG. 6.

FIG. 6 is a flowchart for describing a method of supporting disaster situation management decision-making according to an embodiment of the present invention.

Operation S500 includes operations S510 to S530.

In operation S510, the big data management system 200 stores the situation management big data by acquiring the situation management information from the external system 2 linked for a common disaster.

Operation S520 is an operation of collecting the situation management information that needs to be separately acquired for each disaster type. The situation management service system 100 for each disaster type acquires the situation management information from the external system 1 linked for each disaster type.

In operation S530, the big data management system 200 stores the situation management big data by acquiring the situation management information from the situation management service system 100 for each disaster type.

Operation S600 includes operation S610.

In operation S610, the decision support platform 300 acquires the situation management information necessary for the current situation management work process stage of the situation management target disaster from the big data management system 200.

Operation S700 includes operations S710 and S720.

In operation S710, the decision support platform 300 provides the current situation management work process information for the situation management target disaster to the situation management service system 100 of the relevant disaster type.

In operation S720, the decision support platform 300 provides the current situation management work process information for the situation management target disaster to the situation information sharing and collaboration system 400.

Operation S800 includes operations S810 to S870.

In operation S810, the situation management service system 100 for each disaster type collects, monitors, and analyzes the situation management information necessary for the current situation management work process stage from the external system 1 linked for each disaster type, based on the situation management work process information of the situation management target disaster acquired from the decision support platform 300. The situation management service system 100 for each disaster type generates decision support information (situation management dynamic information or a situation management information visualization viewer) necessary for the current situation management work process stage through the analysis of the collected situation management information.

In operation S820, the situation management service system 100 for each disaster type collects, monitors, and analyzes the situation management information necessary for the current situation management work process stage from the big data management system 200, based on the situation management work process information of the situation management target disaster acquired from the decision support platform 300. The situation management service system 100 for each disaster type generates decision support information (situation management dynamic information or a situation management information visualization viewer) necessary for the current situation management work process stage through the analysis of the collected situation management information.

In operation S830, the situation management service system 100 for each disaster type provides the decision support information necessary for the current situation management work process stage of a target disaster to the decision support platform 300 in the form of the situation management dynamic information and the situation management information visualization viewer.

In operation S840, the decision support platform 300 provides the situation management work process-based decision support information (information on the current situation management work process stage of the relevant disaster, work information to be performed at the current stage, information on considerations to be considered in decision-making at the current stage, an information visualization viewer necessary for decision-making at the current stage, etc.) to the situation manager through the situation manager work PC 3. The work information, consideration information, and information visualization viewer may be a plurality of pieces of information.

In operation S850, the situation information sharing and collaboration system 400 acquires the situation management information necessary for the current work stage from the big data management system 200 based on the situation management work process information of the target disaster acquired from the decision support platform 300.

In operation S860, the situation information sharing and collaboration system 400 acquires the situation management information visualization viewer from the situation management service system 100 of the relevant disaster type based on the situation management work process information of the target disaster acquired from the decision support platform 300.

In operation S870, the situation information sharing and collaboration system 400 provides the situation management work process-based decision support information to the situation board 4 and visualizes the decision support information on the situation board 4 to the situation management decision maker.

Operation S900 includes operations S910 to S930.

In operation S910, the decision support platform 300 acquires the situation management dynamic information for the decision-making and situation changes of the current situation management work process stage of the situation management target disaster from the situation management service system 100 of the relevant disaster type.

In operation S920, the decision support platform 300 acquires the situation management dynamic information for the decision-making and situation changes of the current situation management work process stage of the target disaster from the situation manager work PC 3.

In operation S930, the decision support platform 300 analyzes the situation management dynamic information acquired for the target disaster to determine whether the situation management work process needs to be updated, and if necessary, updates the current situation management work process information of the relevant disaster.

The above procedure may be again performed on the updated situation management work process information from operation S610.

For reference, the components according to the embodiments of the present invention may be implemented in the form of software or in hardware such as a field programmable gate array (FPGA) or an application specific integrated circuit (ASIC), and may perform predetermined roles.

However, “components” are not limited to software or hardware, and each component may be configured to be in an addressable storage medium or configured to reproduce one or more processors.

Accordingly, for example, the components include components such as software components, object-oriented software components, class components, and task components, processors, functions, attributes, procedures, subroutines, segments of program code, drivers, firmware, microcode, circuits, data, databases, data structures, tables, arrays, and variables.

Components and functions provided within the components may be combined into a smaller number of components or further separated into additional components.

In this case, it will be appreciated that each block of a flowchart and combinations of the flowcharts may be executed by computer program instructions. Since these computer program instructions may be mounted in a processor of a general computer, a special computer, or other programmable data processing apparatuses, these computer program instructions executed through the processor of the computer or the other programmable data processing apparatuses create a means for performing functions described in a block(s) of the flowchart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including an instruction means for performing the functions described in the block(s) of the flowchart. Since the computer program instructions may also be mounted on the computer or the other programmable data processing apparatuses, the instructions perform a series of operation steps on the computer or the other programmable data processing apparatuses to create processes executed by the computer, thereby, it is also possible to provide steps for performing the functions described in a block(s) of the flowchart.

In addition, each block may indicate some of modules, segments, or code including one or more executable instructions for executing a specific logical function(s). Further, it is to be noted that functions mentioned in the blocks occur regardless of a sequence in some alternative example embodiments. For example, two blocks that are consecutively shown may be simultaneously performed in practice or performed in a reverse sequence depending on corresponding functions.

According to a decision support system for disaster situation management according to an embodiment of the present invention, it is possible to provide customized decision support information necessary for each disaster type and each disaster situation management work process stage based on the disaster situation management work process to make a decision about systematic situation management.

Since the related art does not systematize knowledge of information necessary for decision-making in situation management for each disaster type and each situation management work process stage and only relies on know-how of a situation manager, there is a problem in that the knowledge is lost when the situation manager is changed. However, according to a decision support system for disaster situation management according to an embodiment of the present invention, it is possible to systematize and preserve the knowledge and continuously use the knowledge.

Unlike the related art that provides situation management information without dividing a work process stage, according to a decision support system for disaster situation management according to an embodiment of the present invention, it is possible to provide only the information necessary for decision-making for each disaster type and each situation management work process stage to support a situation manager to perform situation management work more efficiently

The present invention is applicable to various disaster types and easy to add and change new types of disasters. According to a decision support system for disaster situation management according to an embodiment of the present invention, it is possible to add, change, and link a situation management service system for each relevant disaster type in response to an addition or change of new disaster types. In other words, the present invention has scalability and flexibility for addition and change of disaster types.

In addition, the present invention is applicable to multiple situation rooms, such as a central government situation room and a city and province local government situation room and is easy to add or change a new type of situation room. According to a decision support system for disaster situation management according to an embodiment of the present invention, it is possible to add, change, or link the relevant situation information sharing and collaboration system according to an addition or change of a new situation room. In other words, the present invention has scalability and flexibility for an addition and change to a situation room.

The above-described method of supporting disaster situation management decision-making has been described with reference to the flowchart presented in the drawings. Although the method has been shown and described as a series of blocks for convenience of description, the present invention is not limited to the order of the blocks, some blocks may take place in a different order from or concurrently with those illustrated and described herein for other blocks, and various other branches, flow paths, and orders of blocks may be implemented to achieve the same or similar results. Also, not all illustrated blocks may be required for implementation of the methods described herein.

Hereinabove, the configuration of the present invention has been described in detail with reference to the accompanying drawings, but this is only an example, and thus, can be variously modified and changed within the scope of the technical idea of the present invention by those skilled in the art to which the present invention belongs. Accordingly, the scope of protection of the present invention should not be limited to the above-described embodiments and should be defined by the description of the claims below.

What is claimed is:

1. A decision support system for disaster situation management, comprising:
a situation management service system for each disaster type that provides a situation management service for a specific disaster type;
a big data management system configured to collect, store, and manage situation management big data used for disaster situation management;
a decision support platform configured to manage a situation management work process for each disaster, and provide decision support information necessary for each disaster type and each situation management work process stage; and
a situation information sharing and collaboration system configured to visualize and provide situation management decision support information on a situation board in a specific situation room.

2. The decision support system of claim 1, wherein the situation management service system for each disaster type acquires situation management work process information for a specific disaster type, and collects, monitors, and analyzes information necessary for a current situation management work process stage of the specific disaster type.

3. The decision support system of claim 1, wherein the situation management service system for each disaster type acquires situation management work process information for a specific disaster type, and provides decision support information necessary for a current situation management work process stage of a target disaster of a specific disaster type to the decision support platform.

4. The decision support system of claim 1, wherein the situation management service system for each disaster type provides a situation management information visualization viewer necessary for a current situation management work process stage of a specific disaster type to the situation information sharing and collaboration system.

5. The decision support system of claim 1, wherein the big data management system acquires the situation management information from an external system linked for a common disaster that provides situation management information related to multiple disaster types.

6. The decision support system of claim 1, wherein the big data management system provides situation management information related to a relevant disaster type to the situation management service system for each disaster type.

7. The decision support system of claim 1, wherein the big data management system provides situation management information necessary for situation management of a target disaster to the decision support platform and the situation information sharing and collaboration system.

8. The decision support system of claim 1, wherein the decision support platform provides current situation management work process information for a situation management target disaster to the situation management service system in charge of a relevant disaster type and the situation information sharing and collaboration system.

9. The decision support system of claim 1, wherein the decision support platform provides situation management work process-based decision support information for a situation management target disaster to the situation manager through a situation manager work personal computer (PC).

10. The decision support system of claim 1, wherein the decision support platform acquires situation management dynamic information for a situation management target disaster, analyzes the situation management dynamic information, and if necessary, updates current situation management work process information for the disaster.

11. The decision support system of claim 1, wherein the situation information sharing and collaboration system acquires current situation management work process information for a specific situation management target disaster, and acquires decision support information necessary for the current work process stage and provides the acquired decision support information to the situation board.

12. A method of supporting disaster situation management decision-making, comprising:
acquiring situation management information for a situation management target disaster;
sharing work process information for the situation management target disaster inside a decision support system for disaster situation management;
providing decision support information necessary for a current situation management work process stage to an external system based on the work process information; and
updating current situation management work process information for the situation management target disaster.

13. The method of claim 12, wherein, in the acquiring of the situation management information, the situation management information necessary for the current situation management work process stage of the situation management target disaster is acquired.

14. The method of claim 12, wherein, in the sharing of the work process information, the current situation management work process information for the situation management target disaster is provided to a situation management service system and a situation information sharing and collaboration system of a relevant disaster type.

15. The method of claim 12, wherein the providing of the decision support information to the external system includes:
collecting situation management information necessary for the current situation management work process stage and generating the decision support information necessary for the current situation management work process stage by performing an analysis on the situation management information; and
providing the decision support information necessary for the current situation management work process stage to a situation manager through a situation manager work PC.

16. The method of claim 12, wherein the providing of the decision support information to the external system includes:
collecting situation management information necessary for the current situation management work process stage and generating a situation management information visualization viewer necessary for the current situation management work process stage by performing an analysis on the situation management information; and
providing the situation management information visualization viewer to a situation management decision maker through a situation board.

17. The method of claim 12, wherein the updating of the work process information includes:
acquiring situation management dynamic information for decision-making and situation change of the current situation management work process stage of the situation management target disaster; and
analyzing the situation management dynamic information to determine whether a situation management work process update is necessary, and if it is necessary to update the situation management work process, updating the current situation management work process information for the disaster.

18. The method of claim 12, further comprising, before the acquiring of the situation management information, acquiring situation management information from the external system and storing and managing situation management big data.

19. The method of claim 18, wherein the storing and managing of the situation management big data includes:
acquiring situation management information from the external system and storing situation management big data; and
acquiring situation management information for each disaster type and storing situation management big data.

20. A method of supporting disaster situation management decision-making, comprising:
acquiring situation management information from an external system linked for each disaster type of situation management target disaster;
generating decision support information necessary for a current situation management work process stage based on work process information for the situation management target disaster;
providing the decision support information to the external system; and
updating current situation management work process information for the situation management target disaster.
